(19) United States
(12) Patent Application Publication
(10) Pub. No.: US 2025/0060294 A1
(43) Pub. Date: Feb. 20, 2025

(54) METHOD FOR EVALUATING THE WEAR CONDITION OF A COMPONENT OF A ROTARY PRESS AND A ROTARY PRESS CONFIGURED TO PRACTICE THE METHOD

(71) Applicant: Fette Compacting GmbH, Schwarzenbek (DE)

(72) Inventors: Sven Vulp, Klein Pampau (DE); Jochen Gäth, Schwanheide (DE); Anna Novikova, Hamburg (DE)

(73) Assignee: Fette Compacting GmbH, Schwarzenbek (DE)

(21) Appl. No.: 18/643,314

(22) Filed: Apr. 23, 2024

(30) Foreign Application Priority Data
Apr. 26, 2023 (DE) 102023110808.5

(51) Int. Cl. G01N 3/56; B30B 15/00

(52) U.S. Cl. CPC G01N 3/56; B30B 15/00

(57) ABSTRACT

A method for evaluating a wear condition of a component of a rotary press includes providing the rotary press which includes the component. Values of at least one of: (i) ejection forces acting on the ejector cam during operation of the rotary press; and (ii) vibration frequencies occurring during operation of the rotary press are measured. The wear condition of the component of the rotary press is evaluated based on the measured value.

### CROSS REFERENCE TO RELATED INVENTION

This application is based upon and claims priority to, under relevant sections of 35 U.S.C. § 119, German Patent Application No. 102023110808.5, filed Apr. 26, 2023, the entire contents of which are hereby incorporated by reference.

### TECHNOLOGICAL FIELD

The following disclosure relates to a method for evaluating the wear condition of a component of a rotary press. The rotary press, for example, comprises a rotor that can be rotated by means of a rotary drive and includes an upper punch guide for upper pressing punches and a lower punch guide for lower pressing punches as well as a die plate arranged between the punch guides. The pressing punches interact with cavities of the die plate. The rotary press also includes a filling apparatus by which powder material to be pressed is filled into the cavities of the die plate. The rotary press includes a pressure apparatus which cooperates during operation with the upper pressing punches and with the lower pressing punches to press the powder material into the cavities of the die plate into pellets. The rotary press further includes control cams that cooperate with punch heads of the pressing punches for controlling an axial movement of the pressing punches. The control cams comprise an ejector cam that control the lower pressing punches to eject pellets produced in the cavities from the cavities.

The foregoing disclosure is also directed to a rotary press that includes a rotor with an upper punch guide for upper pressing punches and a lower punch guide for lower pressing punches as well as a die plate arranged between the punch guides. The pressing punches interact with cavities of the die plate. The rotary press also includes a filling apparatus by which powder material to be pressed is filled into the cavities of the die plate. The rotary press also includes a pressure apparatus which interacts during operation with the upper pressing punches and with the lower pressing punches to press the powder material in the cavities of the die plate into pellets. The rotary press further includes control cams that interact with punch heads of the pressing punches to control an axial movement of the pressing punches. The control cams include an ejector cam that controls the lower pressing punches to eject pellets produced in the cavities from the cavities.

### BACKGROUND

In rotary presses, a large number of upper and lower pressing punches are generally provided which are in each case assigned to one cavity of a die plate in pairs. During operation of the rotary press, the upper and lower pressing punches rotate together with the die plate, wherein their axial movement is controlled by means of control cams and is guided by means of upper and lower punch guides. During the course of the rotation, the die plate travels through various apparatuses of the rotary press, namely a filling apparatus, in which powder material to be pressed is guided into the cavities of the die plate, and a pressure apparatus, in which the upper and lower pressing punches are generally pushed into the cavities by means of upper and lower pressure rollers in order to press the powder material into pellets, for example tablets. After the pressure apparatus, the upper pressing punches are guided upward out of the cavities and the pellets produced in the cavities are pushed by the lower pressing punches onto the upper side of the die plate. For this purpose, ejector cams are provided which accordingly move the lower pressing punches upwards. By means of a scraper, for example, the pellets are then scraped off of the die plate into an output of the rotary press, from where they are supplied for further processing.

Rotary presses are operated at high rotor speeds and correspondingly high production speeds. Over the correspondingly large number of pressing processes, wear occurs to various components of the rotary press, in particular the control cams, and here especially the ejector cams which are subject to particular stress during contact with the pressing dies. Contact with the powder material to be pressed can also lead to corresponding wear. Components with increased wear can lead to a worsening of the pellet quality. For example, ejector cams with increased wear can lead to generated defects not being recognized while sorting and bad tablets not being rejected. Up to now, the wear condition of many components of the rotary press, in particular the ejector cams, has been checked at set maintenance intervals, generally manually by an operator. The disadvantage of this is that wear arising in the meantime which can lead to a worsening of the tablet quality will not be detected in time. Manual wear checking is also time-consuming and cannot be reliably reproduced.

Proceeding from the explained prior art, the object of the invention is therefore to provide a method and a rotary press of the type mentioned at the onset, with which the wear condition of components of the rotary press can be evaluated reliably, in a timely manner and reproducibly.

### BRIEF SUMMARY OF THE INVENTION

An embodiment of a method for evaluating a state of wear of the component of a rotary press includes measuring ejection forces acting on the ejector cam during operation of the rotary press using a force sensor and/or measuring vibrations occurring during operation of the rotary press using a vibration sensor. The measured force and/or vibration values are fed to an evaluation apparatus which evaluates the wear condition or state of wear of a component of the rotary press on the basis of the obtained measured force and/or vibration values.

An embodiment of a rotary press capable of performing the inventive method includes at least one force sensor with which ejection forces acting on the ejector cam during operation of the rotary press can be measured as measured values, and/or at least one vibration sensor, with which vibrations occurring during operation of the rotary press can be measured as measured values. An evaluation apparatus is in electrical communication with the at least one force sensor and/or the at least one vibration sensor is provided to which the measured values are applied and which comprises one or more processors configured to evaluate the wear condition of a component of the rotary press on the basis of the obtained measured values.

The basic configuration of the rotary press, as provided according to the present invention and/or as used in the method according to the invention, was explained at the outset. As explained, the upper and lower punch guides guide the pressing punches during their axial movement. The punch heads interact with control cams which move the pressing punches in an axial direction during their rotation with the rotor, in particular towards each other and away from each other. The control cams are generally made of a plurality of control cam elements. They can accommodate the punch heads in corresponding guide holders or only lie against a mirror surface of the punch heads. The pressure apparatus generally comprises an upper pressure roller and a lower pressure roller which interact with the punch heads of the upper and lower pressing punches. A plurality of pressure apparatuses of this type can also be provided, for example pre-pressure apparatuses and main pressure apparatuses. The ejector cam, as a part of the control cams, moves the lower pressing punches upwards after the generation of the pellets in the respective cavity so that the respective pellet reaches the top side of the die plate, from where it can be guided into a tablet outlet, for example by a scraper arranged stationary above the die plate.

According to an embodiment, the ejection forces acting on the ejector cam are measured as measured values during the operation of the rotary press by at least one force sensor, and/or vibrations occurring during the operation of the rotary press are measured by at least one vibration sensor. The measured values are fed to an evaluation apparatus. The evaluation apparatus evaluates the wear condition of a component of the rotary press on the basis of the obtained measurement values. The component is in particular one of the aforementioned components of the rotary press. For example, the component can be a control cam element, such as an ejector cam. The invention is based on the insight that wear of a component of the rotary press is revealed in particular by a change in the ejection forces on the ejector cam and/or a change in the vibrations occurring during the operation of the rotary press. A combination measurement can also be useful such that both the ejection forces measured with a force sensor as well as the vibrations measured with a vibration sensor are detected as measured values and evaluated by the evaluation apparatus. If both types of measured values are recorded, they can each be evaluated in the manner explained above and below. For example, in a comparison of the recorded measured values with reference values, the measured values of the ejection forces are compared with reference values of the ejection forces, and the measured values of the vibrations are compared with reference values of the vibrations. The wear condition can then be evaluated on the basis of both types of measured values. For example, increased wear of the component can be determined if one or if both types of recorded measured values differ from the corresponding reference values. Particularly if both types of measured values are recorded and evaluated, influencing factors acting on one of the measured value type can, for example, be taken into account, or respectively eliminated which lead to a change in the corresponding measured values, but not due to a change in the wear condition. An example would be a change in the web height, that is, the height of the pellets produced in the cavities, or the immersion depth of the press plungers, in particular the upper press plungers, into the cavities, or the lower press plungers when ejecting the pellets from the cavities which have a particular effect on the ejection forces. In additionally taking into account the vibration signals, such influencing factors not associated with the wear condition can be recognized and eliminated.

In an embodiment, the evaluation apparatus may be part of the rotary press. For example, the evaluation apparatus may be integrated into the machine control of the rotary press. In another embodiment, the evaluation apparatus may be configured as a separate component from the rotary press, for example on a computer, tablet or smartphone separate from the rotary press, or on a server separate from the rotary press, for example within the context of a cloud solution.

The invention allows a prediction of the degree of wear of components of the rotary press, in particular in real time. This prediction is performed in a simple and reliable manner by using measurement signals of the ejection force on the ejection cam and/or of vibrations of the rotary press. Since the evaluation of the wear condition according to the invention can be independent of maintenance intervals, in particular continuously during operation of the rotary press, increased wear can be detected in a timely manner. The process stability is increased, and unplanned outages of the rotary press are minimized. At the same time, quality features of the manufactured pellets can be lastingly optimized. The evaluation according to the invention is independent of individual assessments by operators and is therefore reliably and objectively reproducible.

In an embodiment, the evaluation apparatus may include an input apparatus and/or a display apparatus. These may be integrated into the evaluation apparatus or formed separately therefrom, for example in a PC, tablet or smartphone, in particular by an app (application).

The measured values recorded according to the invention are particularly suitable for evaluating the wear condition of the ejector cam. The ejector cam is also relevant with respect to the evaluation of the wear condition since there has previously been no automatic monitoring of the condition of the ejector cam. Only a manual check is performed within the context of set maintenance intervals. According to the invention, it has been recognized that wear of the ejector cam can be reliably detected by the ejection force and the vibration signals.

The force sensor recording the measured values of the ejection force can be arranged on the ejector cam. Currently, corresponding force sensors for measuring the ejection force are already frequently arranged on the ejector cam. However, these have not yet been used for wear detection. For example, a force transducer can be mounted on the ejector cam as a force sensor. The force transducer can, for example, comprise a bending beam with strain gauges and possibly an integrated measuring amplifier. The force transducer arranged for example below the ejector cam is deflected by the forces transmitted by the ejected punch. The ejection force may be determined by means of this deflection.

According to another embodiment, it can be provided that a vibration sensor is arranged on the ejector cam and/or on the pressure apparatus, in particular on an upper and/or lower pressure roller of the pressure apparatus and/or on an upper and/or lower support of the upper and/or lower pressure roller, and/or on a metering cam of the control cams for dosing the powder material filled into the cavities of the die plate. One or more vibration sensors can therefore be provided to record the vibrations arising during operation of the rotary press as measured values. For example, a vibration sensor on the ejector cam, for example on a force transducer, for example on a bending measuring beam of a force transducer, directly measures the vibrations arising in the ejector cam, and can therefore provide very direct information on the wear condition of the ejector cam. However, the inventors have found that vibration signals on metering cam elements, i.e. control cam elements that control (meter) the height of the lower punches when filling the cavities with powder material and on pressure rollers of the pressure device, also provide information on the wear condition of components arranged somewhere else in the rotary press, in particular the ejector cam. It can also be helpful to arrange and use a plurality of vibration sensors. In this way, other effects that perhaps are irrelevant to the wear condition can be identified and eliminated in the evaluation.

The measured values may be recorded as a measured value curve, in particular as a time-dependent measured value curve. For example, the measured values may be recorded as a measured value curve plotted against time, speed or acceleration. The plotting of the measured values as a measured value curve may already be done by the force or vibration sensors, or individual measured values provided by the force or vibration sensors can be recorded by the evaluation apparatus to form corresponding measured value curves. Particularly reliable information on the wear condition of the component may be obtained from a change, in particular in the time characteristic of the recorded measured values.

In a very practical way, the wear condition of the component may be evaluated by the evaluation apparatus on the basis of a comparison of the obtained measured values with reference values. Reference values may be, for example, measured values during operation of the rotary press with a new corresponding component such as a new ejection curve. These reference values form target values with which the measured values obtained later during operation of the rotary press may be compared. The reference values may be historical data from the evaluated rotary press, or data that are saved in a database, and for example saved for the type of respective rotary press. From the determination of a deviation of the currently recorded measured values from the reference values, corresponding inferences about the wear condition of the respective component can be drawn. An influence by other factors that are irrelevant to the wear condition such as for example a web height or an immersion depth of the press plunger, may be eliminated by calculation or measurement, as already explained. In particular, when recording the measured values as measured value curves, they may be correspondingly compared with reference value curves.

According to another embodiment, it may be provided that the evaluation apparatus detects increased wear of the component when there is a shift in the obtained measured values compared to the reference values, and/or when there is a change in the amplitude of the obtained measured values compared to the reference values, and/or when there is a changed slope of the obtained measured values compared to the reference values. It was found that in particular a temporal shift of the high-frequency vibration signal or the high-frequency ejection force signal correlates with the degree of wear of an ejector curve of the rotary press. In addition to the shift, the height or shape of maxima in the high-frequency vibration or ejection force signal is also a parameter indicating the wear condition. For example, with regard to the ejector curve, the impact angle of the pressing punches on the ramp-like ejector curve changes from wear from frequent force-intensive contact with punch heads. This leads to a corresponding shift or changed shape of the maxima in the corresponding measured value curves. Wear of the ejector curve may also be recognized by a change in the acceleration and the level of the amplitude of the vibration signal and/or the ejection force signal. This may also be taken into account by the evaluation apparatus in the described manner.

According to another embodiment, the evaluation apparatus may detect increased wear of the component if the obtained measured values deviate by at least one specified limit value from the reference values. The at least one specified limit value may be specified and/or adapted by an operator. Alternatively or additionally, the at least one specified limit value may be specified and/or adapted by an algorithm, in particular a machine learning algorithm. In addition to an operator, corresponding limit values may therefore also be specified by software or determined depending on the process using reference values of new components, for example new ejector curves. Machine learning algorithms, in particular self-learning algorithms, may also be used to optimize, or respectively adapt specified limit values. An operator may, for example, enter the limit values via an input apparatus of the evaluation apparatus or adapt them according to the respective requirements. Machine learning algorithms may in particular include neural networks.

The evaluation apparatus may display the results of the evaluation of the wear condition of the component to an operator. Furthermore, the evaluation apparatus may output a warning message if increased wear of the component is detected. The display of the evaluation results, or respectively the warning message may be displayed on the aforementioned display apparatus of the evaluation apparatus. The warning message may also include a suggestion for cleaning, and/or reworking, and/or replacing the component with increased wear.

The rotary press, in particular the evaluation apparatus, may be configured to carry out the method according to the invention. Accordingly, the method according to the invention may be carried out using the rotary press according to the invention.

### BRIEF DESCRIPTION OF THE DRAWINGS

An exemplary embodiment of the invention is explained below in greater detail with reference to figures. They show schematically:

FIG. 1 illustrates a plan view of a portion of an embodiment of a rotor of the rotary press according to the invention.

FIG. 2 shows an exemplary diagram of frequency of the vibrations arising during operation of the rotary press.

FIG. 3 shows an exemplary diagram to of measured vibration frequencies recorded by the vibration sensor arranged on the metering cam, which are compared with corresponding reference values.

FIG. 4 shows another exemplary diagram of measured vibration frequencies recorded by the vibration sensor arranged on the upper pressure roller.

FIG. 5 shows another exemplary of a curve based on ejection forces recorded over time by the force sensor arranged on the ejector cam and a comparison curve based on reference value curve for a new ejector cam.

The same reference signs refer to the same objects in the figures unless indicated otherwise.

### DETAILED DESCRIPTION OF THE INVENTION

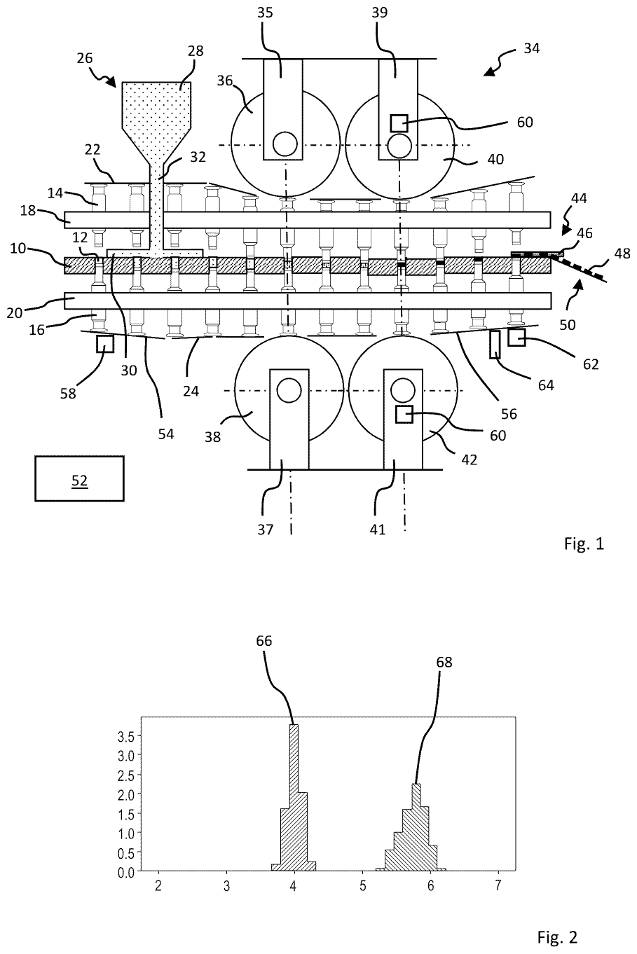

The rotary press shown in FIG. 1 is a rotary press for producing tablets, in which powdered material is pressed into tablets. The rotary press comprises a rotor rotatingly driven by a rotary drive with a die plate 10 having multiple cavities 12. The cavities 12 may be formed, for example, by bores in the die plate 10. The rotor further comprises multiple upper pressing punches 14 and lower pressing punches 16 which revolve synchronously with the die plate 10. The upper pressing punches 14 are axially guided in an upper punch guide 18 and the lower pressing punches 16 are axially guided in a lower punch guide 20. The axial movement of the upper pressing punches 14 and lower pressing punches 16 in the course of the rotation of the rotor is controlled by upper control cam elements 22 and lower control cam elements 24. The rotary press further comprises a filling apparatus 26, which comprises a filling reservoir 28 and a filling chamber 30 which are connected via a filling tube or filling pipe 32. In this manner, in the present example, powder material arrives from the filling reservoir 28 via the filling tube 32 into the filling chamber 30 due to gravity and from there via a filling opening provided on the lower side of the filling chamber 30 into the cavities 12 of the die plate 10.

The rotary press also comprises a pressure apparatus 34. The pressure apparatus 34 comprises a pre-pressure apparatus with an upper pre-pressure roller 36 held on an upper support 35 and a lower pre-pressure roller 38 held on a lower support 37, as well as a main pressure apparatus with an upper pressure roller 40 held on an upper support 39 and a lower pressure roller 42 held on a lower support 41. Furthermore, the rotary press comprises an ejector apparatus 44 and a scraper apparatus 46 having a scraper element which supplies the tablets 48 produced in the rotary press to a discharge apparatus 50 for discharging from the rotary press. The scraper apparatus 46 may, for example, comprise a preferably crescent-shaped scraper element which scrapes tablets 48 conveyed by the lower pressing punches 16 onto the upper side of the die plate 10 in the region of the ejector apparatus 44 off of the die plate 10 and supplies them to the discharge apparatus 50.

Furthermore, the rotary press comprises an evaluation apparatus 52 for controlling the operation of the rotary press and for carrying out the method according to the invention, as explained in greater detail below.

The control cams 24 comprise various control cam elements, inter alia a metering cam 54 and an ejector cam 56. In the shown example, vibration sensors 58, 60, 62 are arranged on the metering cam 54, the upper and lower supports 39, 41 of the upper and lower pressure rollers 40, 42 as well as on the ejector cam 56. The vibration sensors 58, 60, 62 measure vibrations arising during operation of the rotary press in the respective components on which they are arranged. In addition, a force sensor 64 is arranged on the ejector cam 56 to measure the ejection forces acting on the ejector cam 56 during operation of the rotary press by the pressing punches 14, 16. The measured values detected during operation of the rotary press by the vibration sensors 58, 60, 62 and the force sensor 64 are recorded as measured value curves and fed to the evaluation apparatus 52. On the basis of the obtained measured value curves, the evaluation apparatus 52 evaluates the wear condition of the ejector cam 56 of the rotary press in the shown example. Results of the evaluation, or respectively a warning message when there is increased wear may be output on a display apparatus of the evaluation apparatus 52. This may be integrated into the evaluation apparatus 52 or may be formed, for example, by a computer, a tablet or a smartphone. The evaluation apparatus 52 also comprises an input apparatus via which an operator may enter parameters for the condition evaluation by the evaluation apparatus 52, such as for example limit values for deviations from reference value curves. The input apparatus may also be integrated into the evaluation apparatus 52 or formed separately therefrom, for example on a computer, a tablet or a smartphone.

In the shown example, the evaluation apparatus 52 compares the recorded measured value curves of the vibration sensors 58, 60, 62 and the force sensor 64 with reference value curves that for example may have been created experimentally, for example using a new and therefore not worn ejector cam 56. The reference value curves may have been created for the rotary press to be evaluated or for another rotary press of the same type. In particular, the evaluation apparatus 52 may detect increased wear of the ejector cam 56 if, for example, there is a temporal shift of the obtained measured value curves compared to the reference value curves, and/or if the amplitude of the obtained measured value curves is changed compared to the reference value curves, in particular a changed maximum, and/or if the slope of the obtained measured value curves is changed compared to the reference value curves, in particular a changed slope of amplitudes or maxima.

This will be explained by way of example using the diagrams in FIGS. 2-5. In FIG. 2, the reference sign 66 indicates the vibration frequency of the vibrations arising during operation of the rotary press, as measured by the vibration sensor 62 arranged on the ejector cam 56, plotted against the vibration acceleration, in arbitrary units in each case. Corresponding reference values are shown in FIG. 2 with the reference sign 68. It may be seen that, on the one hand, the amplitude, or respectively the maximum of the vibration signals measured by the vibration sensor 62 is higher than with the reference values and, in addition, the vibration acceleration is lower. These deviations of the recorded measured values from the reference values are compared with corresponding specified limit values by the evaluation apparatus 52. If the deviations exceed the limit values, the evaluation apparatus 52 evaluates the ejector cam 56 as having increased wear.

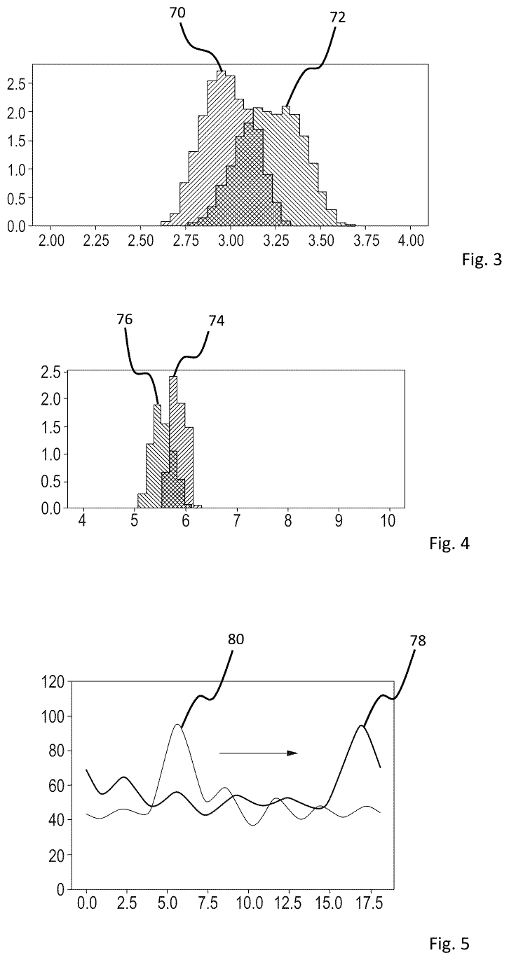

FIG. 3 shows a diagram corresponding to FIG. 2, wherein in this case, at the reference sign 70, the measured values recorded by the vibration sensor 58 arranged on the metering cam 54 are compared with corresponding reference values, and plotted at the reference sign 72. An overlap between the curves 70 and 72 is shown cross-hatched. The deviations identifiable in FIG. 2 may also be identified in FIG. 3, even though they are less prominent due to the arrangement of the vibration sensor 58 on the dosing cam 54. In the same way as explained for FIG. 2, the evaluation apparatus 52 may also evaluate the wear condition of the ejector cam 56 on the basis of the measured values of the vibration sensor 58.

FIG. 4 shows a slightly modified diagram compared to FIGS. 2 and 3 for the measured values recorded by the vibration sensor 60 arranged on the upper pressure roller 40. In FIG. 4, the vibration frequency is plotted against the vibration speed, again in arbitrary units. The measured values recorded by the vibration sensor 60 are indicated with the reference sign 74. Corresponding reference values for a new ejector cam 56 are shown at reference sign 76. An overlap between the curves 74 and 76 is again shown cross-hatched. Again, the evaluation apparatus 52 produces deviations between the measured values that are recognizable and comparable with corresponding limit values. Accordingly, the frequency amplitude, or respectively the frequency maximum of the measured values 74 is higher than with the reference values 76. In addition, the vibration speed is greater than with the reference values. The evaluation apparatus 52 may detect increased wear by comparing with correspondingly specified limit values.

In FIG. 5, a measured value curve of the ejection forces recorded over time by the force sensor 64 arranged on the ejector cam 56 is plotted at the reference sign 78, and a corresponding reference value curve for a new ejector cam 56 is plotted at the reference sign 80. It may be clearly seen that there is a temporal shift of the measured value curve 78 recorded by the force sensor 64 with respect to the reference value curve 80. However, the amplitude of the measured value curves does not change significantly. Again, a limit value for the temporal shift of the measured value curve 78 relative to the reference value curve 80 may be specified, and the evaluation apparatus 52 may detect increased wear of the ejector cam 56 on this basis.

Although the invention was explained with reference to the exemplary embodiment for the evaluation of the wear condition of the ejector cam 56. of course other components of the rotary press may also be accordingly evaluated with respect to their wear condition.

### List of Reference Signs

10 Die plate
12 Cavities
14 Upper pressing punches
16 Lower pressing punches
18 Upper punch guide
20 Lower punch guide
22 Upper control curve elements
24 Lower control curve elements
26 Filling apparatus
28 Filling reservoir
30 Filling chamber
32 Filling tube
34 Pressing apparatus
35 Upper support
36 Upper preliminary pressure roller
37 Lower support
38 Lower preliminary pressing roller
39 Upper support
40 Upper pressure roller
41 Lower support
42 Lower pressure roller
44 Ejector apparatus
46 Scraper apparatus
48 Tablets
50 Discharge apparatus
52 Evaluation apparatus
54 Dosing cam
56 Ejector cam
58 Vibration sensor
60 Vibration sensor
62 Vibration sensor
64 Force sensor
66 Measured values
68 Reference values
70 Measured values
72 Reference values
74 Measured values
76 Reference values
78 Measured values
80 Reference values

1. A method for evaluating a wear condition of a component of a rotary press, comprising:
providing the rotary press comprising,
a rotor configured to be rotated by a rotary drive, wherein the rotor comprises,
an upper punch guide configure to guide upper pressing punches,
a lower punch guide configured to guide lower pressing punches, and
a die plate arranged between the upper and lower punch guides and defining a plurality of cavities, wherein the upper and lower pressing punches interact with the plurality of cavities of the die plate,
a filling apparatus configured to dispense a powder material into the cavities of the die plate,
a pressure apparatus configured to cooperate with the upper and lower pressing punches to press the powder material in the plurality of cavities into pellets, and
a plurality of control cams configured to cooperating with the upper and lower pressing punches for controlling an axial movement of the upper and lower pressing punches, wherein the plurality of control cams includes an ejector cam configured to control the lower pressing punches to eject the pellets from the plurality of cavities;
measuring values of at least one of: (i) ejection forces acting on the ejector cam during operation of the rotary press; and (ii) vibration frequencies occurring during operation of the rotary press; and
evaluating the wear condition of the component of the rotary press based on the measured values.

2. The method according to claim 1, wherein the component of the rotary press is the ejector cam.

3. The method according to claim 1, further comprising obtaining the measured values of the ejection forces acting on the ejector cam during operation of the rotary press by a force sensor arranged on the ejector cam.

4. The method according to claim 1, further comprising obtaining the measured values of the vibration frequencies during operation of the rotary press are configured to be obtained by at least one vibration sensor, wherein the at least one vibration sensor is positioned on at least one of: (i) the ejector cam; and (ii) the pressure apparatus.

5. The method according to claim 1, further comprising generating a time-dependent measured value curve from the measured values.

6. The method according to claim 1, further comprising evaluating the wear condition of the component based on a comparison of the measured values with reference values.

7. The method according to claim 6, further comprising detecting an increase in the wear condition of the component by determining at least one of: (i) a shift in the measured values as compared to the reference values; (ii) a change in an amplitude of the measured values compared to the reference values; and (iii) a changed slope of the measured values compared to the reference values.

8. The method according to claim 6, further comprising detecting an increase in the wear condition by determining a deviation of the measured values from the reference values by at least one specified limit value.

9. The method according to claim 8, further comprising determining the at least one specified limit value by at least one of: (i) an operator; and (ii) a machine learning algorithm.

10. The method according to claim 1, further comprising displaying the wear condition of the component to an operator.

11. The method according to claim 1, further comprising outputting a warning message upon detection of an increase in the wear condition of the component.

12. The method according to claim 11, wherein the warning message further includes a suggestion solution for correcting the increased wear condition, wherein the suggested solution includes at least one of: (i) cleaning the component; (ii) reworking the component, and (iii) replacing the component.

13. A rotary press comprising:
a rotor comprising,
an upper punch guide for upper pressing punches,
a lower punch guide for lower pressing punches, and
a die plate arranged between the upper and lower punch guides and defining a plurality of cavities, wherein the upper and lower pressing punches interact with the plurality of cavities of the die plate;
a filling apparatus configured to supply powder material to the plurality of cavities, a pressure apparatus configured to interact with the upper and lower pressing punches to press the powder material in the plurality of cavities into pellets;
a plurality of control cams configured to interact with the pressing punches to control an axial movement of the upper and lower pressing punches, wherein the control cams comprise an ejector cam configured to control the lower pressing punches to eject the pellets from the plurality of cavities;
at least one sensor, wherein the at least one sensor comprises at least one of: (i) a force sensor configured to measure values of ejection forces acting on the ejector cam during operation of the rotary press; and (ii) at least one vibration sensor configured to measure values of vibrations occurring during operation of the rotary press; and
an evaluation apparatus in electrical communication with the at least one sensor and configured to:
receive the measured values from the at least one sensor, and
evaluate a wear condition of a component of the rotary press based on the measured values.

14. The rotary press according to claim 13, wherein the at least one sensor comprises the force sensor, and wherein the force sensor is arranged on the ejector cam.

15. The rotary press according to claim 13, wherein the at least one sensor comprises the vibration sensor, and wherein the vibration sensor is arranged on at least one of: (i) the ejector cam; and (ii) the pressure apparatus.

16. The rotary press according to claim 15, wherein the plurality of cams includes a metering cam, and wherein the vibration sensor is positioned on the metering cam.
